(19) United States
(12) Patent Application Publication
(10) Pub. No.: US 2012/0060296 A1
(43) Pub. Date: Mar. 15, 2012

(54) FOAM MATTRESS

(76) Inventor: Giacomo Dell'Accio, Laval (CA)

(21) Appl. No.: 13/104,594

(22) Filed: May 10, 2011

Related U.S. Application Data
(63) Continuation of application No. 12/290,162, filed on Oct. 27, 2008, now abandoned.
Application No. 12/290,162 is a continuation-in-part of application No. 11/544,535, filed on Oct. 6, 2006, now abandoned.

(51) Int. Cl. A47C 27/15; B68G 7/00

(52) U.S. Cl. 5/740; 29/91.1

(57) ABSTRACT

A mattress which comprises a centrer core having a top wall, side walls and end walls, and a layer of memory foam enveloping said central core about said top wall, said side walls and said end walls. A method of manufacturing the above mattress is also disclosed.

This application is a Continuation-In-Part of application Ser. No. 11/544,535 filed Oct. 6, 2006, the teachings of which are hereby incorporated by reference.

### FIELD OF THE INVENTION

The present invention relates to cushions and more particularly relates to mattresses having at least one layer of a polyurethane foam material.

### BACKGROUND OF THE INVENTION

Foam mattresses have become highly popular and are gaining a wider acceptance among users. One particular class of foam mattresses utilizes an upper layer of a polyurethane memory foam. This polyurethane memory foam is preferred for the layer on which a person will sit or lie on as it conforms to the shape of the body and has a desirable feel. However, the polyurethane foam is only suitable for the upper portion of the cushion or mattress as it does not provide sufficient support.

It is well known in the art to attempt to control the hardness, softness and support of foam within a cushion or mattress. Generally, the hardness or softness is measured in terms of “indentation force deflection (IFD)” and support (density). Approaches to controlling the hardness and support have included utilizing different types of foam within a mattress. In some instances, various portions of the mattress have different characteristics—i.e. the area intended for the head of the user vis-a-vis the main body portion.

One problem encountered with using different layers of different materials is that generally, the layers are adhered together by using a suitable adhesive material. However, many such adhesive materials, even after being cured, continue to emit certain odours which are annoying to a user and can represent a health hazard.

### SUMMARY OF THE INVENTION

It is an object of the present invention to provide a cushion or mattress which has an upper layer of a polyurethane foam material and which upper layer substantially encases one or more lower layers or vice versa (the bottom layer encases the upper).

According to one aspect of the present invention, there is provided a mattress comprising a center core having a top wall, side walls and end walls, and a layer of memory foam enveloping the center core about the top wall, the side walls and the end walls.

According to a still further aspect of the present invention, there is provided a method of manufacturing a mattress comprising the steps of providing a mold having a base, side walls, and a top wall, placing a center core within the mold leaving a space between the center core and the side walls, end walls and the top wall, and placing a foamable material into said mold whereby the foamable material will foam and envelope the center core about the side walls, end walls and the top wall.

As set forth above, the mattress of the present invention comprises a center core which is enveloped by a layer of foam on the side walls of the center core as well as the top wall. The top side layers are preferably a polyurethane foam and more preferably, a polyerethane visco elastic memory foam.

The center core can be comprised of many different materials and arrangements. In a relatively conventional arrangement, the center core may comprise at least one layer of a foam material. The foam material may be selected from known components. One or more layers may be utilized with each layer or portion having different properties—i.e. one may use a combination of a high resilience foam and a low resilience foam. Other materials such as gels and the like may be used.

In one embodiment of the present invention, the center core may comprise an arrangement wherein the structure includes springs which are then enveloped by the foam. Such structures are well known in the art and need not be detailed herein.

The foam material is preferably a memory foam which is typically foam of a polyurethane composition. Again, such memory foams are well known in the art.

According to a preferred aspect of the present invention, the foam material is formed of a merely natural component and does not use adhesives as is common in other types of mattresses. Thus, in the prior art, some components used in the production of polyurethane memory foams include asocynates, methylene chloride, acetone, benzine, ethylene oxyde, formaldehide, etc. It is known that people can become sensitized after being exposed to as little as 20 parts per billion of certain of the chemicals used in the mattresses.

It is therefore preferred that the foam of the present invention comprise a latex component forming about 10 to 25% by weight, a water component forming between 65 to 85% by weight, vegetable extracts comprising between 2 and 10% by weight, and essential oils comprising between 3 to 8% by weight. The essential oils and vegetable extracts may vary, typical materials will include cone essence, green tea essence, jasmine essence, plant solid extracts, etc. The precise formulation will depend on the final desired properties.

Preferably, the memory foam will have a density of at least 6 pounds per cubic foot. No adhesives are used in the forming of the mattress.

According to the method of the present invention, a mold having a mold cavity conforming to the configuration and size of the desired mattress is provided. The center core is placed within the mold cavity such that the center core is spaced from the side walls and top wall of the mold. Subsequently, the foamable material is placed within the mold and all openings closed to permit the foamable material to foam.

The above arrangement may be accomplished in different manners. In a very basic arrangement, the mold may have a cover which is connectable to the side walls. The cover may be hinged if desired. Locking means are provided to secure the cover in place. Thus, the center core is placed within the mold followed by the foamable material. The cover is then closed and the foamable material allowed to foam.

Naturally, other arrangements can be provided including means for injecting the foamable material into the mold cavity at one or more locations.

Naturally, it will be understood that the term “mattress” may include equivalent structures. Generally, the present invention may be practised to provide any resilient foam requirements such as may be used on futons, beds, chairs, etc.

### BRIEF DESCRIPTION OF THE DRAWINGS

Having thus generally described the invention, reference will be made to the accompanying drawings illustrating an embodiment thereof, in which:

FIG. 1 is a perspective view of a mattress according to an embodiment of the present invention;

FIG. 2 is an exploded view of a mold which may be utilized in the practise of the method of the invention;

FIG. 3 is a top plan view of a portion of the mold, partially in section, of the mattress in the mold;

FIG. 4 is a cross-sectional view of the mattress after molding;

FIG. 5 is a cross-sectional view of a different embodiment of a mattress; and

FIG. 6 is a cross-sectional view of a still further arrangement of a mattress according to the present invention.

### DETAILED DESCRIPTION OF THE INVENTION

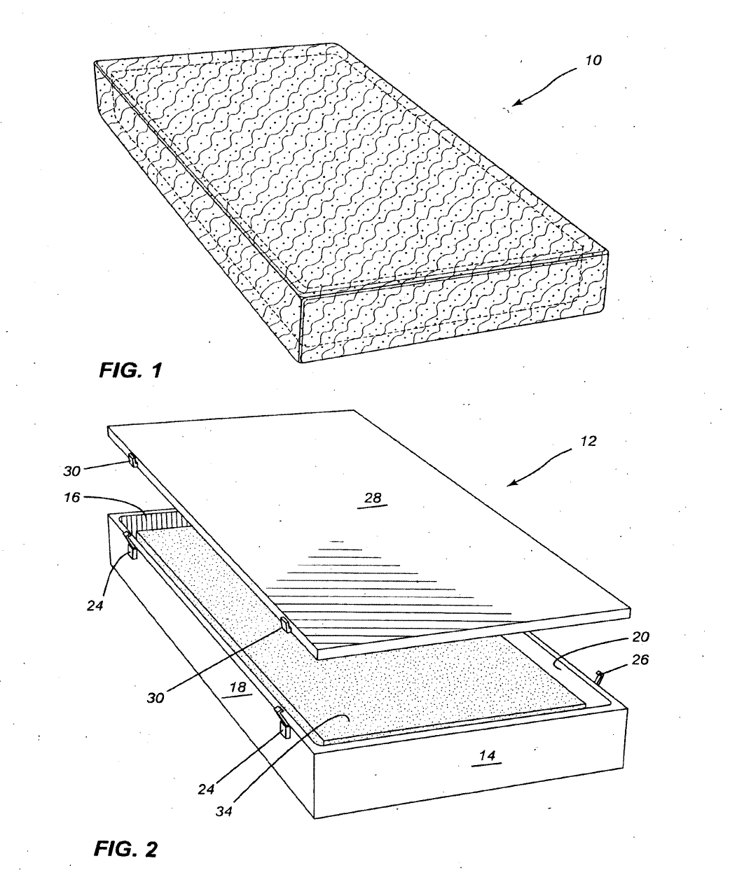

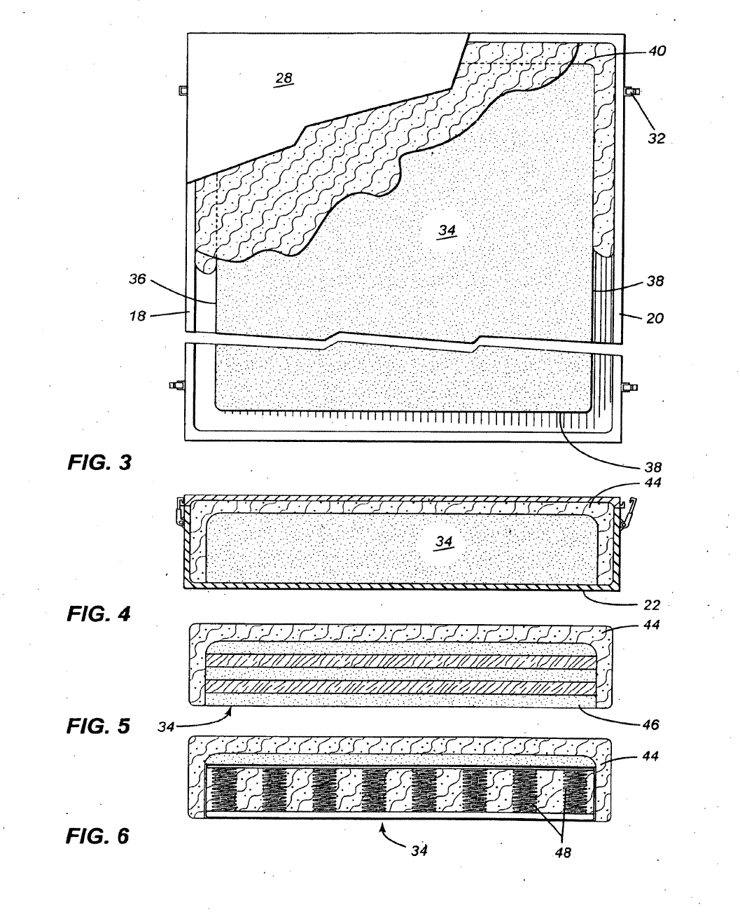

Referring to the drawings in greater detail and by reference characters thereto, there is illustrated in FIG. 1 a mattress according to an embodiment of the present invention and which mattress is generally designated by reference numeral 10.

Referring to FIG. 2, there is illustrated a mold generally designated by reference numeral 12 and which may be utilized to produce mattress 10. Mold 12 has a pair of end walls 14 and 16 along with a pair of opposed side walls 18 and 20. This arrangement provides the mold with an overall rectangular cavity though it will be understood that other configurations may equally well be utilized.

Mold 12 also has a bottom wall 22. Along side wall 18, there are provided latch elements 24 while along side wall 20 there are provided latch elements 26.

A cover 28 is provided with a first set of latch elements 30 and a second set of latch elements 32 with latch elements 30 designed to mate with latch elements 24 and similarly latch elements 26 mating with latch elements 32 to secure the cover in position when desired. It will be understood that other means may be utilized including a hinged type arrangement.

In the method of manufacturing the mattress, a center core 34 is placed interiorly of the mold cavity. Center core 34 has a pair of opposed side walls 36 and 38 and end walls 40 and 42. It will be noticed that end walls 40 and 42 are spaced from end walls 14 and 16 of mold 12 and similarly, side walls 36 and 38 are spaced from mold side walls 18 and 20 respectively. Also, the upper surface of center core 34 is spaced from cover 28.

Subsequently, a memory foam 44 is placed within the cavity and allowed to foam such that it envelopes center core 34 at the end walls, side walls and top. The memory foam is allowed to cure for a suitable period of time and subsequently, the mattress is removed from the mold and allowed to cure for a further period of time, typically 24 to 36 hours.

As shown in FIG. 5, the center core may comprise a plurality of foam layers 46 which may be similar or dissimilar as is known in the art.

In the embodiment of FIG. 6, a plurality of coil springs 48 are utilized along with a pad 50 on top thereof.

It will be understood that the above described embodiments are for purposes of illustration only and that changes and modifications may be made thereto without departing from the spirit and scope of the invention.

1. A mattress comprising:
a center core having a top wall, side walls and end walls; and
a layer of memory foam enveloping said center core about said top wall, said side walls and said end walls, in a non-adhered condition, said center core comprising a plurality of layers of a foam material, at least one of the layers being a high resilience foam and a second layer being a low resilience foam said layers lying adjacent each other in a non adhered condition, said memory foam comprising between 10 to 25% by weight of a latex, between 65 to 80% by weight of water, between 2 and 10% by weight of vegetable extracts, and between 3 to 8% by weight of essential oils.

2. The mattress structure of claim 1 wherein said foam material is a latex foam material.

3. (canceled)

4. The mattress of claim 1 wherein said memory foam has a density of at least 6 pounds per cubic foot.

5.-9. (canceled)
